(19) United States
(12) Patent Application Publication
(10) Pub. No.: US 2008/0208688 A1
(43) Pub. Date: Aug. 28, 2008

(54) METHODS AND SYSTEMS FOR HANDLING OF MOBILE DISCOUNT CERTIFICATES USING MOBILE DEVICES

(75) Inventors: Douglas Byerley, Overland Park, KS (US); Daniel Skowronek, Parker, CO (US); Sunil Dewan, Centennial, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/924,248

(22) Filed: Oct. 25, 2007

Related U.S. Application Data
(60) Provisional application No. 60/912,893, filed on Apr. 19, 2007.
(60) Provisional application No. 60/891,106, filed on Feb. 22, 2007.

(51) Int. Cl. G06Q 20/00; G06Q 99/00

(52) U.S. Cl. 705/14

(57) ABSTRACT

Embodiments of the invention provide methods and systems for handling of mobile discount certificates, including integrating databases of consumer information, product information, discount certificate information, and other useful data with the ubiquitous personal communications networks accessible by the modern consumer. According to one embodiment, a method for handling mobile discount certificates can comprise enrolling a plurality of participants in a mobile discount certificate program. For example, the participants can comprise an issuer of the mobile discount certificates and a customer. A program participant profile can be built for each of the participants. One or more mobile discount certificates can be created based on the program participant profiles and can be communicated to the customer.

### CROSS-REFERENCES TO RELATED APPLICATIONS

This application claims the benefit of U.S. Provisional Application No. 60/912,893, filed Apr. 19, 2007, entitled METHODS AND SYSTEMS FOR HANDLING OF ELECTRONIC DISCOUNT CERTIFICATES and U.S. Provisional Application No. 60/891,106, filed Feb. 22, 2007, entitled MOBILE COMMERCE SYSTEMS AND METHODS, of which the complete disclosures of both are herein incorporated by reference in their entirety for all purposes.

### BACKGROUND OF THE INVENTION

This application is related to discount certificates. More specifically, this application is related to methods and systems for handling of discount certificates using mobile devices.

Recent decades have seen increasing convergence between telecommunications and data services. One catalyst has been the development of digital communication devices and networks which allow providers and users to transmit and receive both data and voice information quickly and reliably around the globe. In fact, a large percentage of consumers in today's marketplace carry one or more mobile communication devices.

These devices include text pagers, cell phones, Blackberrys, and personal data assistants (PDAs), the vast majority of which provide multi-function data processing capabilities. These capabilities—including sending, receiving, securing, computing, and displaying textual and graphical information—bring enormous new potential market opportunities through electronic commerce and customer accessibility. More specifically, the ubiquity of these capabilities provides new opportunities for largely untapped advancements in handling of discount certificates in a mobile commerce environment. For clarification, mobile discount certificates are digital versions of the traditional discount certificates created for use in the mobile commerce environment.

Traditional discount certificates include many different types of transaction instruments, such as payment vouchers, redemption vouchers, coupons, and loyalty programs. These different certificates come in many different forms, including paper, electronic, and gift card; and are usable in many different ways, including for specific items, stores, timeframes, amounts, and conditions.

Use and reconciliation of discount coupons, for example, is typically achieved with the following flow. A company that wishes to issue a coupon to induce customers to purchase its products (an “issuer”) develops the layout for the coupon and provides the artwork to a printer, such as a newspaper or flyer publisher. The customer reviews available coupons in the newspaper, flyer, or other source, and clips those that correspond to products the customer wishes to purchase or is induced to purchase because of the discount. In some cases, the source may be an internet source in which coupons may be selected and printed by the customer directly.

The customer selects the corresponding items when shopping at the supermarket and presents the coupons to the clerk at a checkout terminal. The clerk checks the items and reviews the coupons to determine compliance with the conditions, applying the discounts to reduce the total amount due. In some instances, the discounts may be read from a bar code printed on each coupon with a bar-code scanner. The coupons are put in a drawer at the checkout where all the coupons handled by that clerk accumulate during his shift.

Coupons received by clerks are accumulated at the retail location by the retailer, who periodically sends the coupons to the retailer's headquarters or directly to a retail clearinghouse. The headquarters then periodically sends coupons from their various branches to a clearing house. The retail clearinghouse separates and totals the coupons by manufacturer. Finally, the clearing house processes the coupons to create reports for various interested parties and to obtain reimbursements from the manufacturers or their designated agents for the retailers who accepted the coupons.

There are a number of issues with this typical flow. A first set of issues relates to the amount of time it takes for the transference of physical coupons through the flow. In fact, many coupon transactions require 30 to 45 days of processing before the retail outlet gets reimbursed. This can create cash flow issues and risk, while also slowing potential market feedback mechanisms.

A second set of issues is the large potential for fraud and errors. Checkout clerks may unintentionally ignore the parameters of a coupon, like the specific product, date, geographic, and other limitations on the coupons' redemption. For example, clerks often find themselves facing a large line of customers, each with many items, leaving little time to sort through coupons with specific parameters. Similarly, clerks may ignore the parameters of coupons intentionally either to give discounts to friends, in line with an informal store policy, or for some other reason. Additionally, paper coupons are inherently susceptible to fraudulent redemption and counterfeiting due to the lack of centralized validation and authorization (matching valid coupons to qualifying items in a consumer's purchase). Some retailers even commit large-scale fraud by purchasing large volumes of coupons at low rates and redeeming them with the manufacturer's for their full amount. Whatever the reason, some sources estimate this type of coupon misuse to result in hundreds of millions of dollars of fraud each year in the United States.

A third set of issues relates to the inherent limitations in the physical discount certificate instrument. First, because the coupons come in different sizes with different parameters, they are difficult for consumers to keep track of. Specifically, people must carry around stack of coupons in preparation of buying certain goods from certain stores at certain times. This is inconvenient for consumers and the retailers who accept them. Second, printing and distributing physical coupons can be expensive. Coupons may be mailed out to huge numbers of addresses, with each mailing requiring printing, postage, and other costs. Coupons may also be distributed through Free Standing Inserts in newspapers or attached directly to product packaging. Coupon printing and distribution fees account for nearly half the total costs of coupon programs for manufactures, rivaling the amount of value ultimately redeemed by consumers. Third, because of the inherent limitations of a physical instrument, the coupons are not easily tailored to the specific needs of issuers, retailers, consumers, and other interested parties. The inability to precisely tailor coupons and other discount certificates fails to take advantage of many relatively untapped dimensions to product marketing.

For at least the above reasons, there is a general need in the art to overcome the issues inherent in handling physical discount certificates, including reducing the process flow time, the amount of fraud, and the cost of distribution; while increasing the convenience for consumers, and the tailorability of the instrument.

### BRIEF SUMMARY OF THE INVENTION

Embodiments of the invention provide methods and systems for handling mobile discount certificates using mobile devices. According to one embodiment, a method for handling mobile discount certificates can comprise enrolling a plurality of participants in a mobile discount certificate program. For example, the participants can comprise an issuer of the mobile discount certificates and a customer. A program participant profile can be built for each of the participants. One or more mobile discount certificates can be created based on the program participant profiles and can be communicated to the mobile device, i.e., customer.

Creating one or more mobile discount certificates based on the program participant profiles can comprise receiving discount information from the issuer and creating the mobile discount certificate based on the discount information from the issuer. Additionally or alternatively, creating the mobile discount certificate is further based on the program participant profile for the customer, the program participant profile for the issuer, and/or the program participant profile for an affiliate.

In some cases, the participants can further comprise an affiliate. In such a case, the method can further comprise receiving mobile discount certificate redemption data and authorizing a transaction between the customer and the affiliate based on the mobile discount certificate redemption data. Further, the transaction between the customer and the affiliate can be settled. Information related to the mobile discount certificate can be reported to the issuer. In some cases, the program participant profile for the issuer can be updated based on the information related to the mobile discount certificate.

Communicating the one or more mobile discount certificates to the one or more customers can comprise pushing the mobile discount certificates to a mobile device of the customer. Additionally or alternatively, communicating the one or more mobile discount certificates to the one or more customers can comprise receiving a request for the mobile discount certificate and sending the mobile discount certificate to a mobile device of the customer in response to the request.

According to another embodiment, a system can comprise a communication network, a mobile device of a customer communicatively coupled with the communication network, and a server communicatively coupled with the communication network. The server can be adapted to enroll a plurality of participants in a mobile discount certificate program, wherein the participants comprise an issuer of the mobile discount certificates and the customer, build a program participant profile for each of the participants, create one or more mobile discount certificates based on the program participant profiles; and communicate the one or more mobile discount certificates to the mobile device of the customer via the communication network.

In some cases, the system can further comprise a mobile discount certificate reader communicatively coupled with the communication network. The mobile discount certificate reader can be adapted to receive mobile discount certificate redemption data from the mobile device of the customer and communicate the mobile discount certificate redemption data to the server via the communication network. In such a case, the server can be further adapted to receive the mobile discount certificate redemption data from the mobile discount certificate reader and authorize a transaction based on the mobile discount certificate redemption data. Additionally or alternatively, the server can be adapted to report information related to the mobile discount certificate to the issuer. Additionally or alternatively, the server can be adapted to update the program participant profile for the issuer based on the information related to the mobile discount certificate.

Creating one or more mobile discount certificates based on the program participant profiles can comprise receiving discount information from the issuer and creating the mobile discount certificate based on the discount information from the issuer. Additionally or alternatively, creating the mobile discount certificate can be based on the program participant profile for the customer. Additionally or alternatively, creating the mobile discount certificate can be based on the program participant profile for the issuer.

According to still another embodiment, a machine-readable medium having stored thereon a series of instruction which, when executed by a processor, cause the processor to handle mobile discount certificates by enrolling a plurality of participants in a mobile discount certificate program, wherein the participants comprise an issuer of the mobile discount certificates, a customer, and an affiliate, building a program participant profile for each of the participants, creating one or more mobile discount certificates based on the program participant profiles, and communicating the one or more mobile discount certificates to the customer. Creating one or more mobile discount certificates based on the program participant profiles can comprise receiving discount information from the issuer and creating the mobile discount certificate based on the discount information from the issuer. Additionally or alternatively, creating the mobile discount certificate can be based on the program participant profile for the customer, the program participant profile for the issuer, and/or the program participant profile for the affiliate.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral and follows a hyphen to denote one of multiple similar components. When reference is made to a reference numeral without specification to an existing sub-label, it is intended to refer to all such multiple similar components.

FIG. 1 provides an exemplary illustration of a typical mobile discount certificate program for use with various embodiments of the invention.

FIG. 2 provides an exemplary flow diagram summarizing methods for handling of mobile discount certificates in various embodiments.

FIG. 3 provides an exemplary flow diagram for customer enrollment and profile building in relation to various embodiments of the invention.

FIG. 4 provides an exemplary flow diagram for mobile discount certificate offer creation methods for use with various embodiments of the invention.

FIG. 5 provides an exemplary flow diagram for mobile discount certificate offer communication methods for use with various embodiments of the invention.

FIG. 6 provides an exemplary flow diagram for mobile discount certificate offer creation and communication methods for use with various embodiments of the invention.

FIG. 7 provides an exemplary flow diagram for mobile discount certificate redemption methods for use with various embodiments of the invention.

FIG. 8 provides an exemplary flow diagram for mobile discount certificate reporting methods for use with various embodiments of the invention.

FIG. 9 provides an exemplary flow diagram for mobile discount certificate dispute resolution methods for use with various embodiments of the invention.

FIG. 10 provides a system block diagram illustrating various components for mobile handling of MDCs according to various embodiments of the invention.

FIG. 11 provides a system block diagram illustrating computational devices for mobile handling MDCs according to various embodiments of the invention.

### DETAILED DESCRIPTION OF THE INVENTION

Among other things, embodiments of the invention provide systems and methods for handling of mobile discount certificates using a mobile device in various embodiments, including at least integrating databases of consumer information, product information, discount certificate information, and other useful data with the ubiquitous personal communications networks accessible by the modern consumer.

The invention relates to the handling of Mobile Discount Certificates (MDCs) and MDC programs. MDCs may include any type of instrument issued by an issuer for providing value to a mobile recipient. These instruments may be issued individually or as part of a larger-scale MDC program, whereby an issuer provides multiple MDCs—for example, multiple types of MDC, MDCs to multiple recipients, etc. MDC issuers may include any individual or entity with the capability and authority to provide a MDC, usually but not always within the guidelines of an MDC program. For example, MDC issuers may include manufacturers, banks, good and service providers, and many other types of individuals or entities. Further, MDCs may be used at or through many different types of affiliates, each of whom may or may not themselves be MDC issuers. An affiliate can be any entity that joins an MDC program as an issuer of acceptor of an MDC. For example, MDC program affiliates may include retail outlets, web sites, credit card companies, banks, or any other individual or entity which may benefit from affiliation with an MDC program.

Many different types of MDC are possible. These include, but are not limited to coupons (e.g. providing discounts on goods and services, etc.), “mail-in” rebates (e.g. certificates which promise a rebate for purchasing a good or service which will be processed after the certificate is somehow transmitted back to its issuer or a clearinghouse, etc.), “cash back” rewards (e.g. a certain amount of money discounted from a total purchase, an percentage returned or added to a debit or credit card account after one or a series of purchases, etc.), loyalty coalition points (e.g. frequent flyer miles, hotel points, buyer's club points, etc.), club benefits (e.g. buy nine and get the tenth for free, access to certain promotions, etc.), or any other instrument which can be issued remotely to a mobile device.

By way of example, a person may enroll in a number of different MDC programs, all of which are configured to send MDCs to his mobile phone. While walking through a grocery store, the customer may receive discount coupons and mail-in rebates on his phone for discounts on goods, some being promoted by the grocery store and others by their respective manufacturers. The customer may store all or selected MDC in the mobile phone's mobile wallet. At check out, the retailer may detect the customer's phone via an embodiment of RFID, Infrared, Bluetooth, Cellular or similar technology deployed in the checkout lane, retrieve the information from those MDCs the customer received throughout the store and stored on his mobile phone and matches them with the products the customer purchased. Additionally, based on other MDC programs in which the customer is enrolled, the customer may receive loyalty points for the grocery store buyer's club and cash back to his debit card for one percent of his total purchase.

MDCs may also be used to promote complimentary, substitute, and other goods and services. In one example, a customer who tends to purchase healthy and organic foods may receive MDCs for discounts on Yoga classes or massages. In another example, a store MDC program may detect that a customer who tends to purchase brand name oatmeal just entered the cereal isle, and may wish to offer send the customer an MDC for the store's generic brand oatmeal to promote that item. In yet another example, a store may decide to offer MDCs to all customers currently within the store when the store's inventory system detects that the store is overstocked or under-stocked, that certain perishable products are near their expiration, or in other circumstances.

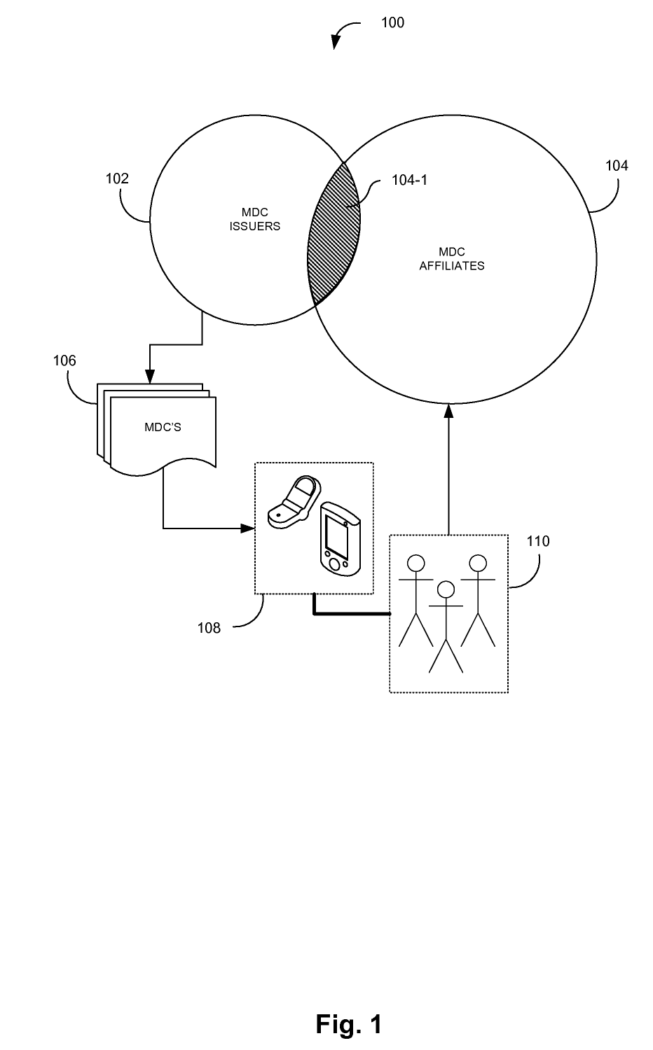

FIG. 1 provides an exemplary illustration of a typical mobile discount certificate program for use with various embodiments of the invention. A MDC program 100 may include a set of MDC issuers 102, a set of MDC affiliates 104, and a set of end customers 110. The set of MDC issuers 102 may include one or more of the same or different types of MDC issuer. Further, some or all of the set of MDC affiliates 104 may themselves be issuers 104-1. For example, say that the MDC program 100 handles mobile discount coupons for groceries at participating grocery stores, redeemable as frequent flyer points for Airline Corp to customers enrolled in the MDC program 100. The set of MDC issuers 102 would likely include Airline Corp. However, the set of MDC issuers 102 would also potentially include Airline Corp's partners, some of the manufacturers of the discounted groceries, and even some of the grocery stores themselves. The set of MDC affiliates 104 would likely include at least those grocery stores and manufacturers or distributors which are participating in the MDC program and are not end customers 110. From this example, it is clear that some or all of the set of MDC affiliates 104 may also be members of the set of MDC issuers 102 (i.e. 104-1). Further, it will be understood that Airline Corp may not be a member of either set (102 or 104); rather Airline Corp may simply sponsor the MDC program 100, giving points and receiving benefits through relationships outside the scope of the MDC program 100.

Some or all the members of the set of MDC issuers 102 may issue a set of MDCs 106 to all or some of the end customers 110 of the MDC program 100 via their respective mobile communication devices 108. Those end customers 110 may then use the received MDCs 106 at one or more of the set of MDC affiliates 104. For example, Super Grocer may issue a text-based discount coupon on strawberries for that subset of customers who have text capability on their mobile devices and who tend to purchase fresh fruit. A customer who received the coupon and purchased strawberries may redeem the coupon when checking out at Super Grocer.

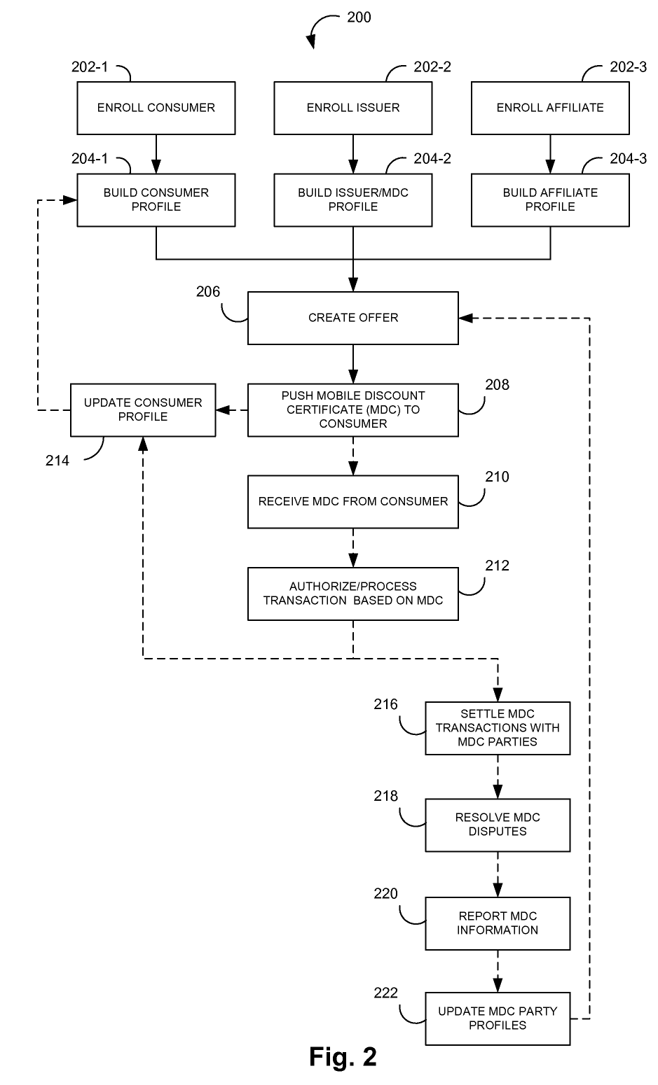

FIG. 2 provides an exemplary flow diagram summarizing methods for mobile handling of discount certificates in various embodiments. The illustrated MDC handling method 200 begins by enrolling MDC program participants 202. This may include enrolling MDC customers 202-1, MDC issuers 202-2, and MDC affiliates 202-3. During or after enrollment, the MDC handling method 200 may build MDC program participant profiles 204.

Using information from the enrollment 202 and profile building 204 processes, along with other information, the MDC handling method 200 may create one or more offers 206. This offer may then be pushed in the form of a MDC to an enrolled consumer 208. In other cases, the consumer may retrieve (i.e., pull) the MDC and save it on the mobile device. A MDC program affiliate may receive the MDC from a recipient consumer 210, and authorize and/or process the transaction based at least on the MDC 212.

At different points along the process, the customer profile may be updated 214 with relevant information. For example, this customer profile update may occur after the offer is pushed to or pulled by the customer 208 or after the transaction has been processed 212. It will be appreciated that it may be beneficial to update the customer profile 214 for many different reasons at many different times.

The MDC handling method 200 may additionally perform processes. These processes may include settling MDC transactions with MDC parties 216, resolving MDC-related disputes 218, reporting MDC-related information to interested parties 220, and updating MDC party profiles 222 (e.g. profiles of MDC affiliates and MDC issuers).

It will be appreciated that many types of MDCs and MDC programs are possible. For example, all or part of the MDC handling method 200 may occur in parallel, in multiple iterations, in multiple locations, or at disparate times. The invention should be construed as broadly as possible to account for the mobile handling of any of these types of MDC handling methods, and their MDCs, programs, issuers, affiliates, and customers.

### 1. Enrollment and Profile Building

In some embodiments of the invention, a party may enroll in a Mobile Discount Certificate (MDC) program. Allowing or requiring enrollment may provide certain benefits to various MDC program parties. One advantage is that a customer enrollment process may provide significant information to MDC issuers and retailers. For example, enrollment is a simple way for those entities to obtain a customer's name, address, and other information. Another advantage is that customer enrollment allows customers to choose whether to opt in or opt out of providing certain types of information, providing them with enhanced privacy opportunities. Other advantages will become more apparent through the discussion below.

Further, enrollment may take a number of different forms. In one form, enrollment may be linked to a particular store, geographical region, brand, manufacturer, bank, credit card, or other such entity. For example, an enrollee may opt to receive certain MDCs as part of a frequent traveler program affiliated with an airline. Similarly, an enrollee may receive certain MDCs in the form of “cash back” on a particular debit card or account.

In another form, enrollment may require payment and/or contractual obligations. This payment may take the form of periodic fees, pre-paid balances, enrollment contracts for a period of time, or other consideration for the service of receiving MDCs. Contractual obligations may also involve agreeing to certain conditions, such as privacy obligations, waivers and indemnifications, or other obligations which may or may not be legally binding. Alternately, the enrollment may be free of charge and/or free of obligation to the enrollee.

In yet another form, an enrollment process may involve the handling of one or various types of MDCs. For example, an enrollee may only desire or be able to receive coupons for goods, store credits, debit card reimbursements, rewards points or products, or other MDCs. Alternately, an enrollment process may allow an enrollee to receive multiple types of MDCs based on any number of factors.

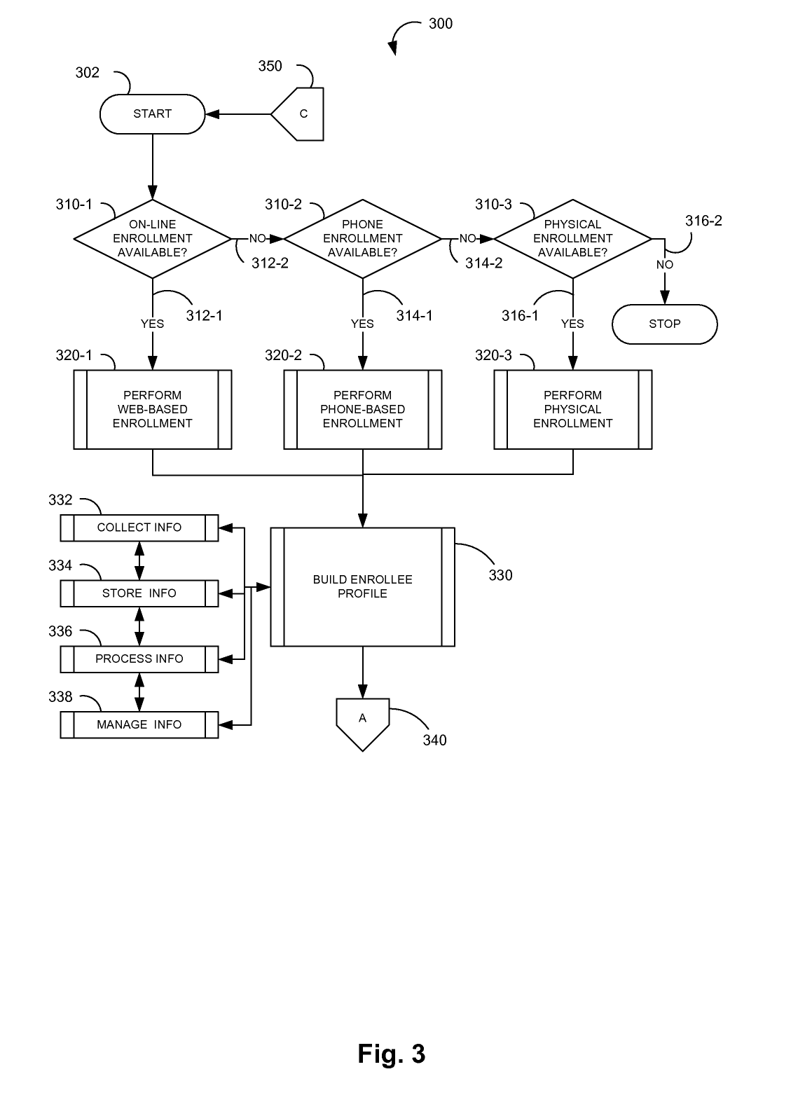

FIG. 3 provides an exemplary flow diagram of methods for enrollment and profile building in relation to various embodiments of the invention. The enrollment and profile building method 300 begins 302 with a set of decision trees 310, relating to certain predetermined types of enrollment vehicles. As illustrated, these vehicles include on-line, phone, and physical enrollment. It will be appreciated that many enrollment vehicles are possible for obtaining the desired (or required) enrollee information. Further, it will be appreciated that the availability of these various vehicles may be polled in different orders, or in series or parallel, if desired.

The enrollment and profile building method 300 determines whether an on-line enrollment vehicle is available 310-1. If an on-line enrollment vehicle is available 312-1 the enrollment and profile building method 300 performs the on-line enrollment process 320-1. This on-line enrollment process 320-1 may employ web-based forms, applets, or any other effective process for obtaining the desired information. For example, the on-line enrollment process 320-1 may use programming languages, such as HTML, Java, and Visual Basic to display questions and options to an enrollee. These options may be in various forms, including radio buttons, text fields, and check-boxes.

Web pages, applets, and other components of the on-line enrollment process 320-1 may be dedicated for the on-line enrollment process 320-1 or may be part of other processes or systems. For example, the enrollment may be part of enrollment into another program, or the web-based form may reside within a frame displayed within another related or unrelated webpage. A customer may, for instance, desire to join a club, apply for a credit card, or register for a mailing list. As part of that process, the enrollee may be given the option to simultaneously enroll in an MDC program. The MDC program may be owned and operated by that same enroller, a partner or affiliate, or some other individual or entity.

Further, the on-line enrollment process 320-1 may be hosted server- or client-side by an enroller or by another individual or entity, or it may reside on the enrollee's client. In one example, the enrollment forms and data collection processes may be hosted by the central servers of a merchant corporation or affiliate. In another example, a program residing on the enrollee's computer may constantly track, store, and update information based on the enrollee's input, web-browsing habits, etc. It will be appreciated that other approaches, including hybrid approaches (where different parts of the process reside in or are performed in different locations), are possible.

Even further, different implementations of the on-line enrollment process 320-1 may yield certain advantages and disadvantages. For example, hosting the information in a central server may allow an enroller to provide enhanced security and other features, like the ability for an enrollee to log in to an account to view account details or change information from anywhere in the world. Of course, this process in this example would also potentially be more vulnerable to attack by hackers, viruses, and other risks.

By way of example, a person wishing to enroll on-line may open a web browser, like Internet Explorer® or Netscape®, on a web-compatible system, like a computer or a smart phone. The person may then enter the web address (e.g. the Uniform Resource Locator, or URL) of the on-line enrollment process. In this example, the person would then see a web page with a server-side enrollment form. The form would ask the person to enter such information as would be desirable to a MDC issuer. After entering the information, the person would transmit the information to a host computer by clicking a “submit” button at the bottom of the form. Before transmission, the form may require that the person agrees to a click-wrap agreement regarding the privacy and security of the data being sent to the host. The process would then set up a secure transmission channel and transmit the information to a host-side application. The host-side application would parse the received information to make sure the information appears valid. For example, it may check to see that email addresses are in the proper form, or that credit card numbers match their correct respective mailing addresses and cardholder names. The host-side application would then store the information in a host-side server.

If there is no on-line enrollment vehicle available 312-2 (e.g. there is no on-line enrollment vehicle at all, the enrollee does not have adequate capability or compatibility to participate in on-line enrollment, the on-line enrollment system is not functioning or is short on bandwidth, etc.), the enrollment and profile building method 300 may determine whether a phone-based enrollment vehicle is available 310-2. If a phone-based enrollment vehicle is available 314-1, the enrollment and profile building method 300 may perform the phone-based enrollment process 320-2. This phone-based enrollment process 320-2 may employ Dual-Tone Multiple-Frequency (DTMF) tones, live operators, voice recognition systems, or any other effective process for obtaining the desired information. It will be appreciated that at least because of the multi-function capabilities of many communication devices, it may be desirable to utilize these functions separately or in conjunction with various phone-based functions. For example, it may be desirable to send text, images, video, or other information to a live operator during a live phone-based enrollment process.

Further, the phone system or phone-based enrollment process 320-2 may be able to detect and even take advantage of certain capabilities or compatibilities of the enrollee's communication device. For example, the phone-based enrollment process 320-2 may detect that the enrollee's phone is text (SMS) compatible and may allow the phone-based enrollment process 320-2 and enrollee to communicate in whole or in part via text messaging. Similarly, the communication device may be capable of instant messaging, email, voice over internet protocol (VOIP), and/or many other protocols, applications, and other capabilities. Other types of capabilities may also include security features and proprietary protocols and standards.

If there is no phone-based enrollment vehicle available 314-2 (e.g. there is no phone-based enrollment vehicle at all, the enrollee does not have adequate capability or compatibility to participate in phone-based enrollment, the phone-based enrollment system is not functioning or is short on bandwidth, etc.), the enrollment and profile building method 300 may determine whether a physical enrollment vehicle is available 310-3. If a physical enrollment vehicle is available 316-1, the enrollment and profile building method 300 may perform the physical enrollment process 320-3. This physical enrollment process 320-3 may employ forms, documents, contracts, surveys, or any other effective process for obtaining the desired information. The physical enrollment process 320-3 may be performed at a point of sale, at a check-out kiosk or register, at a dedicated kiosk or station, by email, by facsimile, or at some other location capable of performing the physical enrollment process 320-3. It will be appreciated that many types of physical and virtual input devices and protocols are possible for performing this physical enrollment process 320-3. For example, there are many different types, shapes, sizes, and weights of paper, carbon paper for duplicates, touch screens, handwriting recognition systems, biometric readers, magnetic stripe readers, etc. To speed up the physical enrollment process 320-3, for example, an enrollee may go to a dedicated kiosk with a number of input devices. He may swipe a credit card to automatically provide information like his name and billing address, and to allow the process to run a credit check to determine certain authorizations, interest rates, credit ratings, promotions, etc. The kiosk may then print out a partially filled-in form or provide a virtual form on the screen to obtain other types of information.

If no enrollment vehicles are available 316-2, the enrollment and profile building method 300 may terminate 318.

It will be appreciated that for the different enrollment processes 320, the enrollment may or may not occur in real-time. For example, any of the enrollment processes 320 may be connected to an enrollment system which creates a user account as the information is entered. Alternately, the enrollment process 320 may be connected to an enrollment system, but may wait until some or all the information has been entered before processing the enrollment. In another alternative, the enrollment process 320 may print, send, or otherwise provide the enrollee with enrollment information to complete and return at a later date. This may be sent to or returned by the enrollee via mail, facsimile, email, drop-box, or in any other effective way.

After the enrollment vehicle is determined 310, and either during or after performance of the enrollment process 320, the enrollment and profile building method 300 may perform a profile building process 330. The profile building process 330 may or may not depend on the type of enrollment process or processes 320 used. In general, the profile building process 330 may include information collection 332, information storage 334, information processing 336, information maintenance 338, and other useful steps.

Information collection 332 may require determining which types of information are necessary or desirable depending on the type of MDC program or issuer. For example, a gift card program may require as little as the balance remaining on the account to be associated with a card account number or other designator; while a credit card loyalty coalition program may require significant amounts of personal and financial information, as well as information on affiliated entities, goods, and services. It will be appreciated that myriad types of information may be required or desired for different types of MDC programs. These data may include, but are in no way limited to, personal information (e.g. name, address, billing address, birthday, marital status, or children), real-time information (e.g. current geo-location information, items currently being purchased, or device currently being used), tendency information (e.g. shopping history, web-browsing history, favorite merchants or brands, favorite colors, or favorite flavors of ice cream), socioeconomic information (e.g. income, occupation, credit information, age, race, or gender), technical information (e.g. mobile device type, service provider, operating system, software/hardware/firmware version, or protocol compatibility), affiliation information (e.g. credit/debit card accounts, loyalty coalition memberships, clubs, or partnerships), and statistical information (e.g. cell phone minutes used per month, times of day when shopping most frequently occurs, or average number of times per month a stock trade is executed).

Information collection 332 may involve allowing the enrollee to opt-in or opt-out of disclosing certain types of information. This opt-in/opt-out capability may be desirable for reasons such as providing a more comfortable experience for the enrollee, or may even be required—for instance by law—to comply with certain data privacy or security laws. For example, an enrollee may not want to include information about his favorite products for any number of reasons, including fear of embarrassment, fear of spam or junk mail, or lack of time to enter more that the required information during the enrollment. Further, a customer may be comfortable entering information during enrollment, but may want to opt-out of having the MDC program track his purchasing habits after the enrollment is complete.

Of course, information collection 332 may involve certain amounts of required and optional data, and data which may be filled-in automatically by some process. Further, depending on how the data is stored, processed, and managed by the enrollment and profile building method 300, the enrollee may have the opportunity to add, modify, or delete some or all of the information entered during the enrollment process 320.

During or after information collection 332, the information may be stored 334. Information storage 334 may occur on a flat or relational database, file structure, dedicated or non-dedicated server, or any other effective data storage device. The data store may be collocated with the data collection vehicle (e.g. within a kiosk, within a client-side application or cookie, etc.), remote, distributed, or in any other useful system architecture. Further, the information storage 334 may occur in any useful data structure, including as a page in a stack of paper, or as a relational data structure with multiple dimensions of highly-searchable attributes.

It may also be desirable to perform information processing 336. Information processing 336 may utilize any number of useful data processing functions, including performing sorts, statistical and trend analyses, parsing, redaction, modification, format translation, and correction. In one example, during or after the enrollee enters his city and state, the profile building process 330 may automatically determine the enrollee's zip code, geographic region, socioeconomic data, nearby retailer locations, and other useful collateral information. In another example, either while or after an enrollee enters a set of preferences, the profile building process 330 may extrapolate that information to develop a set of recommended goods, services, or merchants based at least in part on the entered data.

The profile building process 330 may also manage the enrollee's information 338 to allow the enrollment and profile building method 300 to enhance its efficacy over time. In one example, the enrollee may be able to log in to a website and add preference or other information over time. In addition to using this new information, the enrollment and profile building method 300 may also be able to use data associated with the change in information to learn more about the enrollee (e.g. how often the enrollee logs in to update information, which information he tends to update, what dime of day he most commonly updates, changes in his personal or financial information, etc.). Similar types of data may also help the enrollment and profile building method 300 improve over time (e.g. by determining when bandwidth is most in demand, by running statistics on which types of users change which types of data, by analyzing browsing patterns, by recording which types of enrollment vehicles are most utilized for which types of functions, etc.).

Managing information 338 may also be desired or required as part of legal, economic, or other regimes. For example, it may be legally required to remove certain types of financial information from a system after a certain amount of time. Similarly, it may be desirable to archive certain data after some temporal or other condition is met.

During or after the profile building process 330 is preformed, the profile information may be passed to other methods at least via Connector A 340.

It will be appreciated that the enrollment and profile building method 300 may be used, either identically or in modified forms, for different types of enrollees. Different types of enrollees include, but are not limited to customers with disparate needs, merchants wishing to be MDC program affiliates, MDC issuers, reporting and auditing groups, and any other party for which a profile may be useful.

### 2. Mobile Discount Certificate Offer Creation and Communication

An important part to a MDC program is the creation of MDC offers for its customers. MDC offers may include any required or desired information relating to a MDC. For example, if the MDC is a discount coupon, the MDC offer may include information about the eligible customers (e.g. those within certain geographic regions, with certain socioeconomic attributes, displaying certain tendencies, etc.), information about eligible products or services (e.g. those from certain manufacturers or distributors, with certain expiration dates, in certain geographic regions, at certain price points, in certain quantities, at certain retail outlets, etc.), or other types of information (e.g. necessary secondary authorization, coupon expiration, coupon text, copyright and trademark licenses, transmission protocol, format, etc.). In another example, if the MDC is a credit card offer, the MDC offer information may include risk-related information needed for choosing eligible customers, like ranges of allowed credit ratings, other account affiliations, etc.

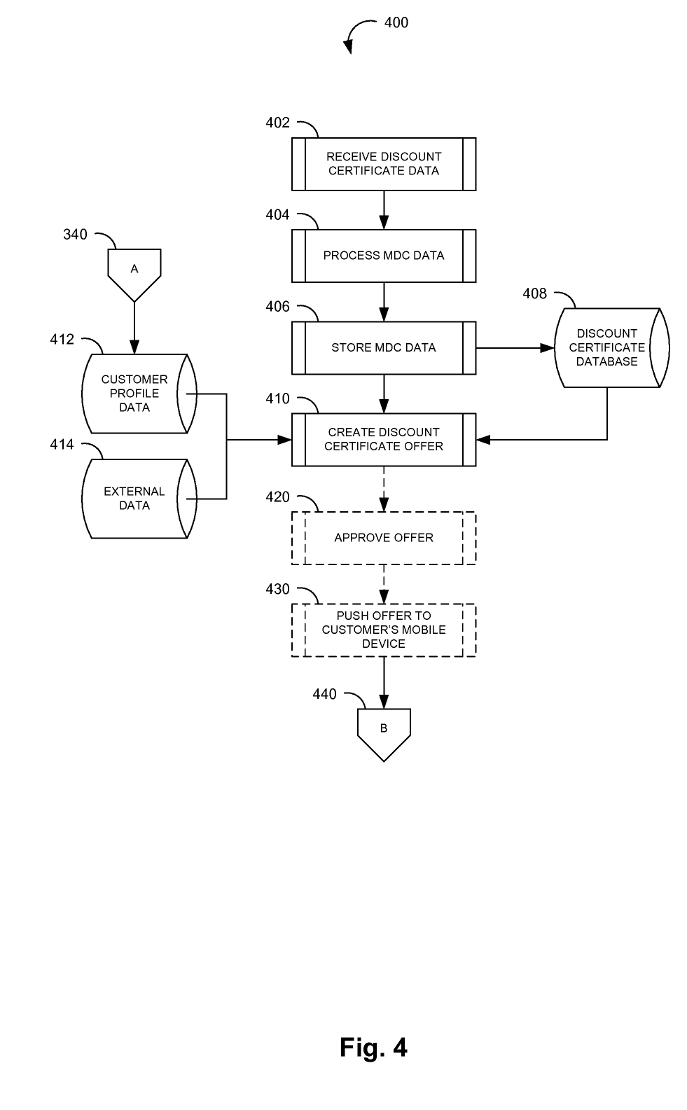

FIG. 4 provides an exemplary flow diagram for MDC offer creation for use with various embodiments of the invention. The offer creation method 400 receives MDC data 402. This data may be generated manually, automatically, or by some combination. The MDC data may be sent by an MDC issuer or by some automated system which may or may not be affiliated with the MDC program or its participants.

The offer creation method 400 may then process the MDC data 404. Processing the data 404 may include parsing or translating a submission from an issuer or system, sorting the data, queuing the data with data for other MDCs, or any other useful data processing function. For example, it may be desirable to sort or queue the data from various MDC offers by time, region, eligible customers, etc. For another example, the data may be submitted in a format which is incompatible with a database which stores the offer data, requiring that the data be reformatted (manually or automatically) to be compatible.

The data may then be stored 406. Storing the data 406 may involve different types of storage, including short-term storage, like storage contemporaneous with transmission or storage in the memory of an intermediate system, and longer-term storage, like storage in a large relational database of data from multiple MDC offers. Thus, data may be stored 406 in one or more databases 408 or other effective data stores. Storing the data may 406 also require or involve compliance with certain types of data privacy and security policies, laws, or regulations. For example, it may be necessary to create secure storage and transmission channels, using passwords, encryption, and other types of physical and virtual security measures.

Once the MDC data is available, it may be possible to create a MDC offer 410. Creating the offer 410 may require polling both stored and real-time information from a number of different sources. In a first example, a MDC offer is simply a discount coupon being issued to all MDC program customers. There, it is likely that all the information needed to create the offer 410 was made available as part of the MDC data receipt 402, processing 404, and storage 406. In a second example, the MDC offer may include a number of related but different discount coupons being automatically tailored to specific criteria. For instance, the MDCs may all be coupons for cereal, but the brand of cereal may adjust to the customers preference tendencies; the amount of the discount may adjust to the customer's income; the expiration date may adjust to the customer's shopping history; the applicable stores and regions may adjust to the customer's present real-time location; and the format of the coupon (e.g. text with a coupon code, barcode, near-field communication, etc.) may adjust to the compatibilities of the customer's local affiliate points of sale. In this second example, much of the information required for creating the offer 410 would not be available as part of the MDC data. In fact, the MDC data may simply be a set of algorithms, formulas, and ranges. Instead, the relevant information may require access to such information as customer profiles, affiliate profiles, network provider information, inventory information, etc. In these cases, it may be necessary or desirable for the offer creation 410 to utilize profile data 412 (perhaps deriving from an enrollment and profile building method via connector A FIG. 3, 340), and other external data sources 414.

During or after the creation of the offer 410, one or more of the offers may require approval 420. Offer approval 420 may include a batch process or may be performed on individual offers. Further, the offer approval 420 may be automated or manual. For example, sets of offers may be automatically checked for formatting issues. For another example, an issuer or affiliate may desire to manually check each offer before it is sent to any customer to make sure all the information is correct. It will be appreciated that many different types of approval may be desired or required, some of which may necessitate access to and comparison with various internal and external sources of data.

The offer may then be pushed to a customer's mobile device 430. Pushing the offer 430 may involve transmitting the offer via one or more networks. These networks may be dedicated, public, private, or any other effective type, and they may or may not be secure. It will be appreciated that there are many effective ways to communicate an offer to a mobile device. Further, these different types of communications may depend at least in part on the types of mobile devices and protocols which are available or in use, bandwidth issues, and other transmission-related concerns.

Even further, it will be appreciated that communicating an offer may involve either pushing the offer to the customer or pulling (e.g. downloading) the offer from the issuer, affiliate, or other source. For example, a MDC issuer may own a server which can send MDCs to all eligible customers' phones via email. For another example, a customer may log in to a mobile coupon application and download one or more coupons. For yet another example, a customer may wave his Bluetooth phone over a device which receives, stores, and transmits MDC offer data from a number of different MDC issuers and MDC programs.

Still further, a customer may receive MDC offers singly or in batches, for a variety of reasons. In one example, a customer may receive offers as they are transmitted, unless his mobile device is out of memory, not receiving service, or turned off. In those cases, the customer may receive a set of offers as soon as his device's condition is adequately corrected. In another example, a customer may receive offers only when he requests them, at which point he may receive one or multiple offers depending on certain preferences. In a third example, the customer may have the capability of receiving one or more offers at any time, and receives them in whichever condition depending on how they are transmitted.

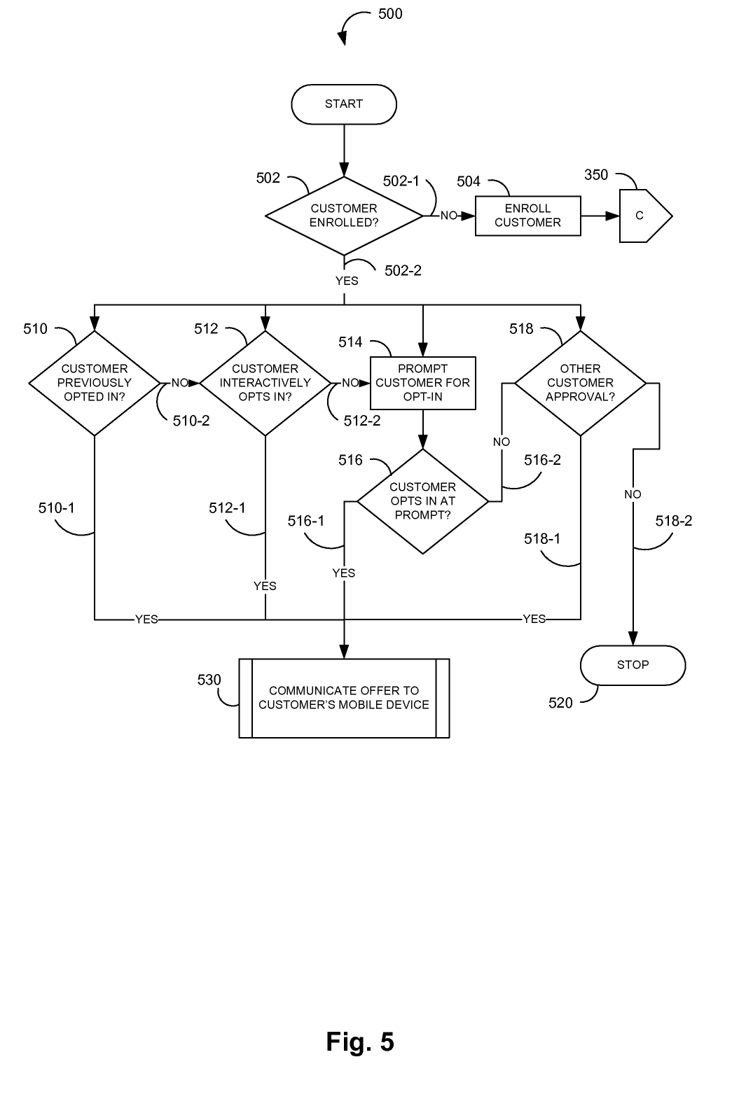

FIG. 5 provides an exemplary flow diagram for MDC offer communication for use with various embodiments of the invention. In this exemplary flow diagram, the offer communication method 500 first detects whether the customer is enrolled 502 as part of a MDC program. If not 502-1, the method attempts to enroll the customer 504, likely by proceeding to an enrollment and profile building process, for example through connector C 350 (FIG. 3).

If the customer is enrolled 502-2, the offer communication method 500 may proceed with one or more options, in series or in parallel. In one option, the offer communication method may determine whether the customer previously opted in 510 to receiving MDC offers. For example, the customer may have previously opted in by checking a box during the enrollment process, by running an application on his mobile device, or in any number of other suitable ways. This previous opt-in process may allow the customer to opt in for the duration of his enrollment period, for a limited time, for only certain types of offers, or with many other parameters, potentially requiring a more thorough inquiry by the offer communication method 500. If the customer previously opted in 510-1, the offer communication method 500 may then communicate the offer to the customer 530.

If the customer did not previously opt in 510-2, the offer communication method 500 may determine whether the customer has interactively opted in 512. Interactive opt in processes include any process by which a customer interacts with a specific offer to opt in for that offer. In some interactive opt-ins, the customer would receive notice of an offer or group of offers and be required (or may desire) to first opt in before receiving any actual offers. For example, an icon or message may appear on the customer's mobile device, informing him that offers are waiting (e.g. “Press ‘1’ to view offers”).

In some other types of interactive opt-ins, certain technologies would allow the customer to interact with some part of an offer creation system. For instance, there may be near-field communication (NFC), Bluetooth, radio-frequency identification (RFID), optical, electromagnetic, audio, or other types of offer transceivers. These transceivers may be stand-alone devices or incorporated into advertisements, posters, products, facilities, kiosks, point-of-sale devices, or any other vehicle accessible by a customer. With compatible technology on the customer's mobile device, the customer may be able to interact with the offer transceiver to opt in for an offer.

In one example of this type, next to a toothpaste display in a store, there may be an advertisement for a new toothbrush, the advertisement containing a NFC offer transceiver. When an enrolled customer with an NFC-enabled cell phone waves his phone over the advertisement (i.e. over the offer transmitter), he is interactively opting in to receiving an offer. The offer may be a coupon for a half-price toothbrush with the purchase of toothpaste, a link to a web address for more information on tooth decay, a sample pack of sugar-free chewing gum mailed to the customer's mailing address, etc.

In another example of this type, a customer may have a communication channel between his mobile device and his laptop computer. This communication channel may be, for example, a dedicated peripheral device (e.g. a universal serial bus (USB) NFC reader), an embedded sensor (e.g. a Bluetooth sensor on the face of the laptop), or a port (e.g. a USB port, a firewire port, an optical port, etc.). Through this communication channel, the customer may be able to interactively opt in 512 to receive or use MDCs with online merchants.

There may also be hybrid types of interactive opt-ins. For example, a customer may previously opt in to receive all offers from a particular store. The MDC program, mobile device, affiliate, or some other entity or device may then know of the arrangement and wait for some interactive communication from the device to complete the opt-in. Perhaps, the customer opted in online and downloaded an opt-in key (e.g. a cookie, etc.) to his mobile phone. Then, whenever the customer walks by a smart advertisement (e.g. a poster with an NFC-enabled offer transceiver), his smart (e.g. NFC-enabled) phone would automatically receive offers under conditions dictated by the opt-in key.

Similarly, the interactive opt-in process may require other authorization or validation for receipt of offers. For example, a customer with an NFC-enabled phone may have to place his thumb on a fingerprint reader, which would then communicate with his NFC-enabled phone to validate the biometric identifier against data stored in the phone. It will be appreciated that many types of single and multiple authentication are possible in conjunction with embodiments of the invention. If the customer interactively opted in 512-1, the offer communication method 500 may then communicate the offer to the customer 530.

If the customer did not interactively opt in 512-2, the offer communication method 500 may prompt the customer to opt in 514. Prompting the customer for opt-in 514 may include any process for polling the customer for authorization and receiving a response. For example, the prompt may include a visual cue (e.g. a text message, an icon, a flashing ‘?’, etc.), an audible cue (e.g. a tone, a melody, etc.), an electromechanical cue (e.g. a flashing light, a vibration, etc.), or any other effective cue. Further, the prompt may be produced in any effective location, including at the mobile device, at an offer transceiver, etc.

After prompting the customer to opt in 514, the offer communication method 500 may determine whether the customer opts in at the prompt 516. If the customer opts in at the prompt 516-1, the offer communication method 500 may then communicate the offer to the customer 530.

It will be appreciated that there are many other ways for customers to opt in for offers. Of course, it may be desirable to not require opt-in at all, to allow or require opt-out, or some other authentication or validation paradigm.

Thus, if the customer does not opt in at the prompt 516-2 (e.g. the customer actively responds in the negative, passively waits for the prompt to expire, etc.), the offer communication method 500 may determine whether there is some other customer approval 518 for receiving the offer. If there is some other customer approval 518-1, the offer communication method 500 may then communicate the offer to the customer 530. If there is no other customer approval 518-2, the offer communication method 500 may terminate 520.

It will be appreciated that the offer communication method 500 may terminate 520 after any step for various reasons. Some reasons include accidental or involuntary reasons, like termination of a network connection, failure of an application, expiration of an offer, etc. Other reasons may be more purposeful, including only providing certain opt-in options and not others (e.g. terminating 520 if the customer did not previously opt in 510). Further, it will be appreciated that these different communication steps may be performed and options may be provided in various orders without departing from the offer communication method 500 or the invention.

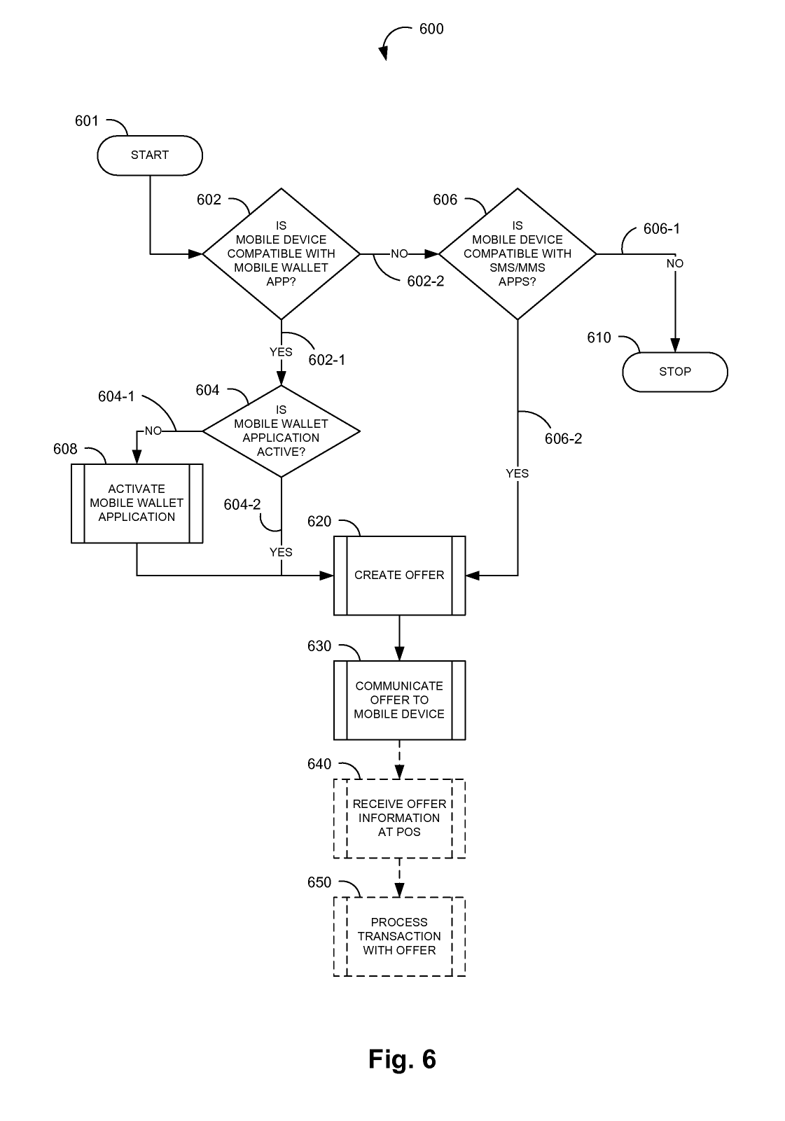

By way of example, FIG. 6 provides an exemplary flow diagram for a MDC offer creation and communication methods for use with various embodiments of the invention. The offer creation and communication method 600 in this example involves a MDC program which utilizes an application called Mobile Wallet. This application may intend to convert the user's mobile device into a multi-functional transaction instrument. For example, the application may allow the user to pay for goods and services, receive payments for goods and services, and accept MDCs for use with various transactions. Of course, an application like Mobile Wallet may require enrollment, opt-in, and any of the other capabilities or requirements mentioned above.

As such, the offer creation and communication method 600 begins 601 by determining whether the customer's mobile device is compatible with Mobile Wallet 602. If the customer's mobile device is compatible with Mobile Wallet 602-1, the offer creation and communication method 600 may determine whether the Mobile Wallet application is active 604. Of course, applications like Mobile Wallet may act on the mobile device in various ways, including being always active, active only on the user's request, etc. If the Mobile Wallet application is not active 604-1, the offer creation and communication method 600 may activate the application 608 (e.g. by remote activation, by prompting the customer for activation and waiting for the user to activate the application, etc.).

If the customer's mobile device is not compatible with Mobile Wallet 602-2, the offer creation and communication method 600 may determine if a different compatible protocol is available. In the illustrated case, the offer creation and communication method 600 determines whether the customer's mobile device is compatible with a messaging protocol 606, like SMS (short messaging service) or MMS (multi-media messaging service).

If there is no compatible protocol for receiving offers 606-1, the offer creation and communication method 600 may terminate 610.

If either the Mobile Wallet application is active 604-2, the Mobile Wallet application was activated 608, or there is another compatible protocol for receiving offers 606-2, the offer creation and communication method 600 may create an offer 620 for the customer. Once the offer has been created 620, the offer creation and communication method 600 may proceed under various desired or required conditions to communicate the offer to the customer 630, to receive the MDC at a point of sale 640, to process transactions based at least in part on the MDC 650, and other functions.

It will be appreciated that many types of MDC offers are possible for all the many types of MDCs, customers, mobile devices, affiliates, issuers, etc. Thus, the invention should be construed as to allow the creation and communication of these many types of MDC offers.

### Mobile Discount Certificate Redemption and Settlement

Once MDC offers have been communicated to recipients, the recipients may redeem the offers. Of course, the redemption of an offer may depend on the type of offer, recipient, issuer, affiliate, or other parameters. Further, an offer may not be redeemed, such as a coupon which has expired or has been deleted or withdrawn. As such, many different MDC offer redemption methods are possible. Redemption refers to the transfer of value to an MDC redeeming consumer. Settlement refers to paying the MDC acceptor for any value transferred and appropriate handling fees due from the MDC issuer. The issuer can create and releases the MDCs for distribution, creating potential financial liability equal to the value of all MDCs distributed and any handling fees by MDC acceptors. Once an MCD is presented to and ‘redeemed’ by an MDC acceptor, a portion of the potential obligation becomes an actual obligation. Payment of the actual obligation between the acceptor and the issuer can be resolved through the settlement process.

Generally speaking, once the MDC is present and authorized (which may include validation), the value is calculated and the MDC value can be released to the consumer in real time and at the POS (i.e., the MDC is redeemed). The redeeming party, i.e. the retailer has now delivered the value to the consumer and should be reimbursed by the issuer for any value transferred to the consumer and any handling/distribution fees that may be due based on the contractual environment. Settlement may also incorporate reporting functionality.

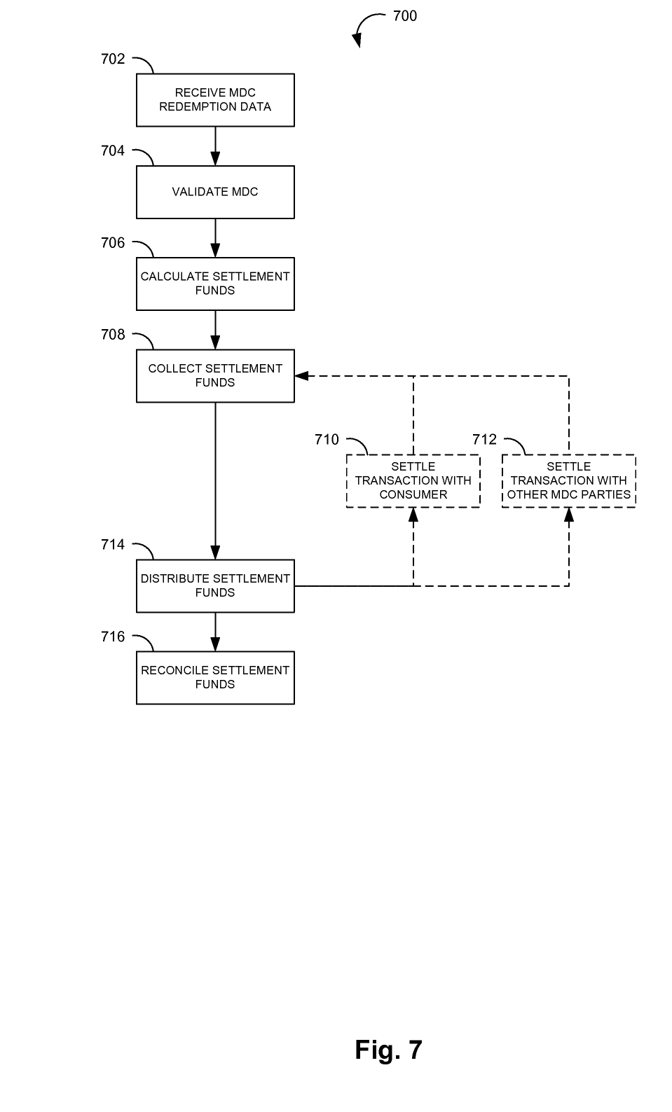

FIG. 7 provides an exemplary flow diagram for MDC redemption methods for use with various embodiments of the invention. The MDC redemption method 700 begins by receiving MDC redemption data 702. This redemption data may include some or all of the MDC data from the customer's mobile device, and/or other data relating to the point of sale, purchased goods or services, date and time, MDC issuer, or any other relevant data.

For example, say the MDC is a discount coupon for a fifty-cent discount on orange juice. The redemption data may include data from the MDC (e.g. coupon code, expiration date, discount value, eligible goods, customer authorization, customer information, mobile device information, etc.), from the point-of-sale store computer (e.g. stock keeping unit (SKU) of the purchased orange juice, store identifier, time and date stamp, etc.), from the MDC issuer (e.g. issuer identifier, issuer routing information for settlement, issuer authorization, etc.), or any other information needed or desired for the redemption of the MDC.

It will be appreciated that receiving the MDC redemption data 702 may be performed in one or more stages from one or more sources. Further, receiving the MDC redemption data 702 may require connections to multiple networks and systems, multiple types of hardware and software, and/or multiple types of authorization.

During or after receiving the MDC redemption data 702, the redemption data may be validated 704. Validation data may be part of or separate from the redemption data, and may be received in a similar or different way. Validation data may include authorization 705 from the customer's mobile device, the MDC issuer, the MDC affiliate, the MDC acceptor, or one or more other sources.

In one example, validation may be possible using information only from the customer's mobile device. One reason may be that the MDC issuer decided to require little or no validation for the MDC. Of course, this may open the offer to fraud or other misuse, but may be desirable for some reason. Another reason may be due to some aspect of the validation data. It may be, for instance, that an encryption key associated with the MDC is algorithmically related to the serial number of the customer's mobile device, allowing the MDC to self-validate.

In another example, multiple data may be required for validation. One type of validation may simply require an MDC code to match a code in the MDC affiliate's or issuer's system. Another type may require an algorithmic relationship between information from the MDC and another source. It will be appreciated that many validation methods are available in the art to accomplish this step in the MDC redemption method 700.

At this point, the MDC redemption method 700 may calculate MDC settlement funds 706. Calculating MDC settlement funds 706 may utilize at least a portion of the MDC redemption data and any other data useful in the calculation.

Say a customer purchases ten energy bars and presents a “ten energy bars for $10” promotional MDC at the check-out register. In one example, the MDC may represent an internal promotion for which the merchant merely sacrifices a portion of its profit margin on energy bars. As such, the merchant may only need to use the value presented by the MDC (i.e. ““ten energy bars for $ 10”) and the fact that the consumer did, indeed, purchase ten energy bars to calculate the settlement funds. The settlement funds, in this simple case, may include all or some of the $10 needed from the consumer, the reduction in profit margin of the merchant, etc. In another example, the MDC may represent a complex partnering arrangement between the MDC issuer (maybe the energy bar manufacturer), and various affiliates, including the merchant and maybe also the energy bar distributor and others. Here, the settlement fund calculation may be much more complex, involving, for example, MDC processing and handling fees from various parties, percentage splits of MDC revenues, and many other data. Of course, the types of data which may factor into the equations are at least as varied as the potential types of arrangements between interested parties to the transactions. For instance, settlement funds may even have to account for such fees as relate to trademark licenses for logos, bad debt fees for misused or unused MDCs, etc.

Once the settlement funds have been calculated 706, the settlement funds may be collected 708. This may include collecting settlement funds from other parties interested in the MDC transactions. Of course, because of the various types of MDCs and settlement funds, collecting settlement funds 708 may be performed in various ways. Similarly, funds which must be collected from other parties interested in the MDC transactions may be transferred as known in the art when settling conventional discount certificates.

Further, settlement funds may be collected 708 as single transactions, in periodic batch reconciliations, or in any other useful way. For example, it may be desirable or necessary to settle multiple transactions at once when settling MDC transactions with other parties interested in the MDC transactions. These periodic settlements (e.g. once per month, once per quarter, in $1000 increments, etc.) may lower transaction costs, highlight certain trends, enhance security, or provide other useful benefits. Alternatively, various parties may desire or require that transactions are settled at or near the time of that transaction. For example, a merchant may desire to receive funds due from an MDC issuer as soon as possible after the MDC is processed. This may reduce various risks involved with, for example, bad debt, time value of money, contractual relationships, etc. Further, in the world of electronic money transfer, this type of arrangement may not significantly affect transaction costs between the parties.

Once settlement funds have been calculated 706, and perhaps after settlement funds have been collected 708, the settlement funds may be distributed 714. As with the collection of settlement funds 708, funds may be distributed to consumers or to other interested parties in different forms, to various locations, and at different times. Further, settlement funds may be distributed 714 as single transactions, in periodic batch reconciliations, or in any other useful way.

For example, it may be desirable to settle MDC transactions with consumers at the end of a check-out session (e.g. after all the customer's purchases for that shopping excursion have been scanned by the cashier, all the related MDC settlement funds have been calculated, and a total has been calculated), rather than at the time each MDC is processed. In this way, it is possible to settle multiple MDC transactions at once, and possibly even use those MDC transactions to affect the final total before payment is required. Say, for instance, that a customer uses three different MDC discount coupons at check-out. Instead of halting the check-out process each time an MDC is presented to settle the transaction with the consumer, the check-out clerk or computer may simply apply all the coupons to the final total, resulting in fewer funds being required from the consumer at the end of the transaction.

Similarly, it may be desirable to periodically distribute payments to other interested parties. For example, some environments are such that items are regularly returned or exchanged. In these environments, collecting settlement funds 708 and distributing settlement funds 714 after each transaction would create a more complete transaction record, allowing the interested parties to closely evaluate each transaction for fraud, trends, etc. On the other hand, this individualized settlement may create a messy transaction record, making it difficult to ascertain bigger picture financial situations and trends.

During or after either the collection of settlement funds 708 or the distribution of settlement funds 714, is may be desirable to reconcile 716 the settlement funds. Reconciling 716 the settlement funds may ensure that the appropriate parties have paid or have been paid their respective amounts. Further, reconciling 716 the settlement funds may be necessary or desirable to make sure that other parties unrelated to the MDC (e.g. the customer's credit card company or mobile device service provider) have completed their respective portions of any transactional or contractual obligations.

It may also be desirable to reconcile 716 MDC transaction information other than settlement funds. In some cases, for example, multiple parties may have access to or control over all or some of the transaction information. This transaction information may include any information relating directly or indirectly to a MDC transaction (or set of transactions), such as MDC information, profile information, contractual information, protocol information, etc. Reconciling 716 this information may help meet certain ends, including ensuring that MDC transactions run accurately and efficiently, minimizing fraud, simplifying information audits and recovery, etc.

To effectuate reconciliation 716, and perhaps other processes, it may be necessary or desirable for there to be one or more information hosts. These hosts may perform a number of information-related functions, including owning and/or managing data servers, acting as trusted third party information repositories, acting as third party MDC program mediators, etc.

It will be appreciated that many MDC redemption methods are possible for the many types of MDC-related scenarios. As such, the invention should be construed broadly to account for these various types of MDC redemption methods.

### Mobile Discount Certificate Program Reporting

In many cases, it may be desirable to report information relating to MDCs and their offers, affiliates, issuers, customers, and other related data. Because of the many types of MDCs, interested parties, transactions, relationships, and other variations, many different types of reports may be desired or required.

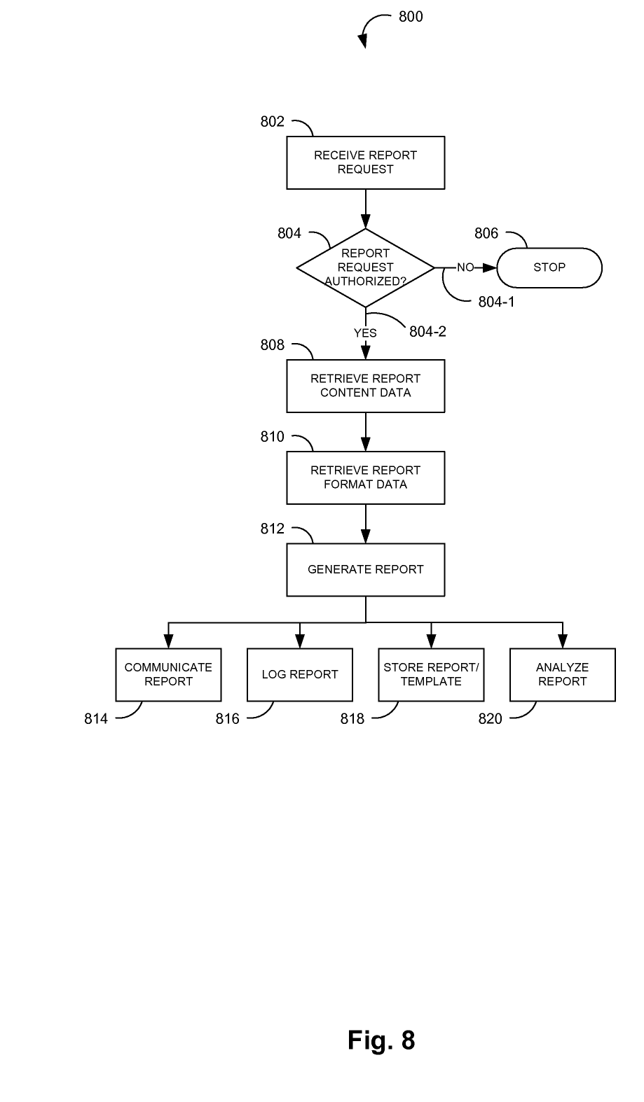

FIG. 8 provides an exemplary flow diagram for MDC reporting methods for use with various embodiments of the invention. The MDC reporting method 800 receives a report request 802 from a requester. Requests may come from many different sources, including parties to a MDC program, system owners or administrators, auditors, agencies, etc. Further, the requests may be received 802 in many different forms, including physically (e.g. by mail, memorandum, orally, etc.), electronically (e.g. by email, web form, phone, facsimile, text message, automated request, etc.), or in any other effective way. Even further, requests may be made on ad hoc, periodic, or other bases. In one example, customers may be able to log into their MDC program accounts and print ad hoc or batch reports of account activity. In another example, affiliates may receive automated monthly batch reports of all MDC activity from their stores, stemming from automated requests by some system.

Of course, different requestors may have access only to certain information. Therefore, the MDC reporting method 800 may authorize or validate the report request 804 before providing access to any information. Authorizing the report request 804 may involve acquiring information from the requester. This information may include all or some of the information in the report request. Further, authorizing the report request 804 may require manual or automated review of report requests, possibly including a need to consult extrinsic sources of information. For example, an agent of an affiliate may have to provide a code which matches an affiliate-specific code in a database before being granted access to certain information, thus requiring the authorization step 804 to search for that affiliate-specific code on a different system. In another example, after a customer report request is received 802, the MDC reporting method 800 may begin to authorize the report request 804 by sending an email to the requester. The requester may then have to follow instructions in the email to be authorized.

If the report request is not authorized 804-1, the MDC reporting method 800 may terminate 806. If the report request is authorized 804-2, the MDC reporting method 800 may begin to retrieve report content data 808. The retrieved report content data may be any or all of the requested and authorized MDC information, plus any additional information which may be required or desired content for the authorized report (e.g. header information, form text, etc.). Retrieving the report content data 808 may require running one or more query, sort, or other data processing or manipulation function.

Additionally, the MDC reporting method 800 may retrieve report format data 810. Report format data may include any type of formatting information which may be needed or desired for creating the authorized report. For example, report format data may include information about fonts (e.g. size, color, face, character spacing), page setup (e.g. margins, justification, line spacing, numbering), images (e.g. placement, resolution, size, text wrap), protocol (e.g. file type, output compatibility), and any other useful formatting information. Further, it may be desirable to retrieve different formatting data 810 for different compatible applications. For example, the report may be displayed on a computer monitor before being printed from a peripheral printer, potentially requiring the report to be formatted differently for those two output devices.

During or after retrieving report content data 808 and retrieving report format data 810, the report may be generated 812. Generating the report 812 may require different steps depending on the type of output device. In one example, if the output device is an unformatted query result, the report may be simply the query result written to a binary file. This report generation 812 may require little or no data translation, formatting, or other steps. In another example, the report may be merged into a highly formatted report template for professional printing. This report generation 812 may require extensive data processing, formatting, and translation, as well as potential error checking and other functions.

One the report is generated 812, the MDC reporting method 800 may perform a number of steps, including communicating the report 814, logging the report 816, storing the report or template 818, and analyzing the report 820.

Communicating the report 814 may involve outputting the report to an output device or file. For example, the report may be displayed, printed, or electronically transferred (e.g. to a file, network, email address, internet location, etc.). The format of the output may depend in part or in whole on the received report format data or other formatting sources. Further, the output may involve one or more transfers to one or more file types. These file types may include simple binary or ASCII file types, complex proprietary file types (e.g. Microsoft Excel®), custom file types, or any other useful file type.

Logging the report 816 may include generating, appending, or modifying one or more log files on one or more systems. Logging reports 816 may be performed for various reasons. For example, it may be desirable to see which requesters requested which report types, audit authorizations, check system security, develop statistical analyses, store intermediate queries and results for later use, etc. Report logs may also be accessible for future report requests, to allow some requesters to be able to generate reports of report logs for various purposes.

Storing the report 818 may involve creating or modifying one or more files on one or more systems. Reports may be stored 818 in physical or electronic formats on any effective media. For example, reports may be stored as collated print-outs, files on a data server, removable disks, etc. Further, reports may be stored with various other features, including encryption, write-protection, duplication, authentication information, etc. It may also be desirable to store only portions of the report. This may include portions of the report data, query or other data processing information, report formatting as a template, or other information the retrieval of which may be desired or required in the future. Additionally, some or all the data may be stored for various amounts of time, including for the life of the storage medium, for some predetermined interval, contemporaneous with a transmission, or in any other useful way.

Analyzing the report 820 may include performing any of various manual or automated data processing functions on the report data. These data processing functions may include performing statistical analyses, performing mathematical algorithms, sorting, parsing, querying, queuing, or any other useful functions.

It will be appreciated that many MDC reporting methods are possible for the many types of MDC-related reports. As such, the invention should be construed broadly to account for these various types of MDC reporting methods.

### Mobile Discount Certificate Dispute Resolution

At various times and for various reasons, disputes will arise relating to MDCs. These disputes may be between any parties to MDCs, and may include disputes over any aspect of MDCs, such as related programs, transactions, authorizations, functionality, etc.

One category of disputes may be those originating with customers. These may include, for example, disputes over mishandled transactions (e.g. a value was incorrect, a discount never appeared on a statement, etc.), failed technology (e.g. the MDC offer did not download properly, a customer account could not be accessed online, etc.), transactional changes (e.g. returns, refunds, exchanges, store credits, etc,), and other customer disputes (e.g. failed privacy policies, customer service questions, account changes, etc.). Another category of disputes may be those originating with other MDC parties, like MDC affiliates and issuers. These may include, for example, disputes from affiliates over disbursements (e.g. a transaction settlement was incomplete, a report was incorrect, etc.), disputes from issuers over MDC issuance (e.g. a MDC was not issued, a MDC was issued with the incorrect information or to incorrect customers, etc.), and other non-customer disputes (e.g. party relationship issues, technology compatibility and functionality issues, etc.).

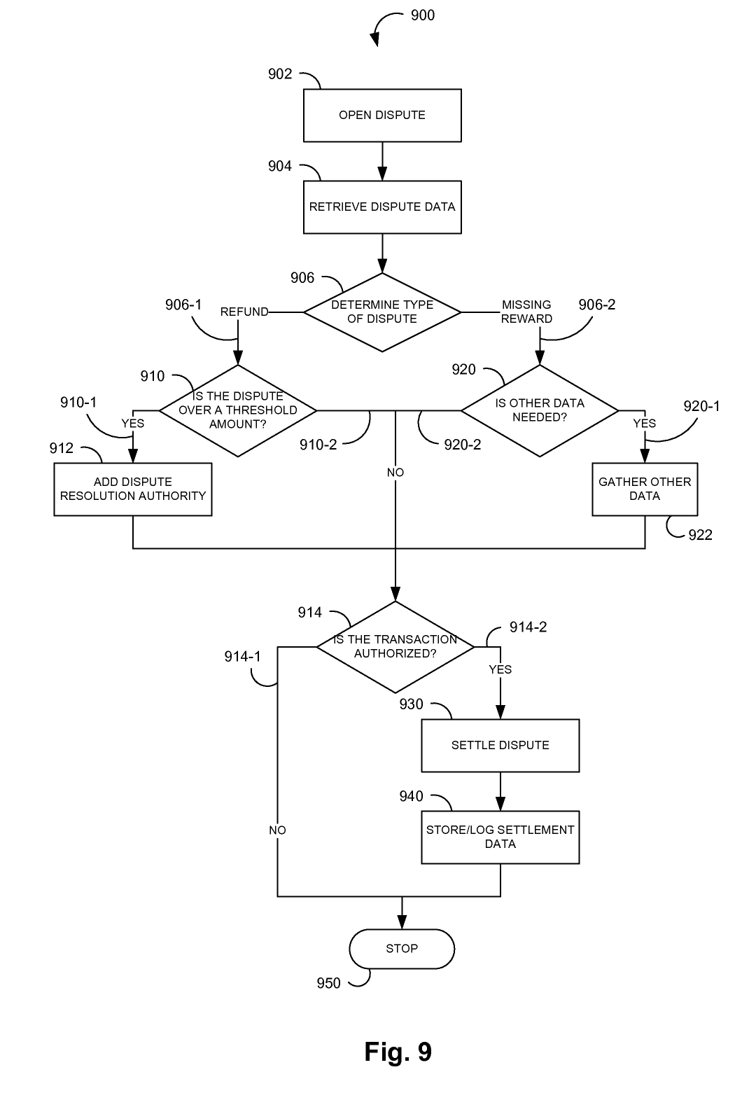

FIG. 9 provides an exemplary flow diagram for MDC dispute resolution methods for use with various embodiments of the invention. More specifically, FIG. 9 relates to MDC dispute resolution methods for customer disputes over returns, refunds, and missing rewards.

The MDC dispute resolution method 900 may begin by opening a dispute 902. A dispute may be opened 902 by any authorized or interested party. For example, a customer may open a dispute after noticing an incorrect transaction. In another example, an affiliate or issuer may open a dispute on behalf of a customer after detecting a transaction error. Disputes may also be opened 902 in a number of ways, including by phone, by email, at an Internet address, in person, by mail, at a dedicated or related terminal, or in any other effective way at any of various types of dispute resolution system. Where disputes are opened 902 in person, the dispute resolution system may include computer systems, live service representatives, or other useful elements located at one or more of various locations accessible to the customer (e.g. an affiliate location, a dedicated dispute resolution center, a kiosk, etc.). Where disputes are opened 902 remotely, the customer may have to communicate dispute resolution information with a remotely-located dispute resolution system located at, for example, an Internet address, a post office box, an office building, or any other effective location, including a location where the customer could have otherwise opened a dispute 902 in person. Further, disputes may be opened 902 manually, by automated systems, or in hybrid (e.g. semi-automated) systems. Opening a dispute 902 may include such steps as creating one or more dispute files (e.g. physical or electronic), assigning one or more dispute numbers (e.g. record numbers or tracking numbers), or any other useful steps.

The MDC dispute resolution method 900 may then retrieve dispute resolution data 904. This data may be necessary or desirable at least for aiding in the resolution and/or recordation of the dispute. Dispute data may be retrieved 904 from any source capable and/or authorized to provide the needed or required data. Further, the Dispute data retrieval 904 may be performed differently depending on the type or method of dispute resolution. For example, the dispute data may be retrieved 904 from a customer by phone, from a database over a network, from a bank by fax, or from any other useful source in any other useful way. The retrieved data may include any data useful for resolving the dispute, or perhaps other information for use in analyzing trends, keeping records, complying with legal regimes, or other purposes. For example, the retrieved dispute data may include customer information (e.g. name, address, phone number, account number, etc.), MDC information (e.g. type of MDC, issuer, where and when used by the customer, etc.), and any other useful information.

At least partly using the dispute resolution data, the MDC dispute resolution method 900 may then determine the type of dispute 906. In this exemplary method, the dispute is either the result of a refund 906-1 or a missing reward 906-2. If the dispute is a refund 906-1 (e.g. a reversed transaction, or part of a returned or exchanged product transaction), it may be desirable to have different dispute resolution methods depending on the size of the dispute (e.g. the money value in question, the number of transactions in question, the types of products in question, etc.). For example, the size of the dispute may determine such aspects of the method as include which individuals or systems have what authority (e.g. whether management approval is needed), how much information must be collected to resolve a dispute (e.g. whether a social security number or other customer validation is needed), and what types of dispute resolution are available (e.g. cash back versus store credit). To effectuate this, the MDC dispute resolution method 900 may determine whether the dispute is over some threshold amount 910. This threshold may be determined prior to the dispute, ad hoc for each transaction, or in any other useful way. Further, the threshold may depend on the type of dispute, and/or on some algorithm. For example, the threshold may be set by an automated system based on a mathematical function of the amount of money the disputer has spent at a particular affiliate location in the past year.

If the dispute is over a threshold 910-1, dispute resolution authority may have to be added 912. This may include retrieving additional information or authorization, passing information to another department or authorization level, etc. If the dispute is not over a threshold 910-2, or if the dispute is over a threshold 910-1 and dispute resolution authority has been added 912, the MDC dispute resolution method 900 may determine whether the transaction is authorized 914.

If the transaction is not authorized 914-1, the MDC dispute resolution method 900 may terminate 950. If the transaction is authorized 914-2, the MDC dispute resolution method 900 may settle the dispute 930. Settling the dispute may involve steps including refunding the value of the disputed transaction to the disputing customer, closing the dispute, etc.

Further, the MDC dispute resolution method 900 may store or log data from the dispute resolution 940. It will be appreciated that depending on the type of MDC (e.g. its associated information, programs, issuers, affiliates, customers, etc.), dispute resolution data may be stored 940 in various locations (e.g. on paper, in files, in a database, at an affiliate's or issuer's home office, etc.), by various parties (e.g. by affiliates, by issuers, by a central host, etc.), in various formats (e.g. printout, flat file, relational database, formatted report, etc.), and for various reasons (e.g. record keeping, trend analysis, legal obligation, etc.).

At this point, the MDC dispute resolution method 900 may perform other dispute resolution steps or terminate 950.

Moving back now to determining the type of dispute 906, the dispute may be determined to have been a result of a missing reward 906-2 (e.g. the MDC transaction did not appear on a statement, a reward never arrived, a reward issuer was not notified of the award, etc.). In these cases, the MDC dispute resolution method 900 may determine whether additional dispute data is needed 920. This may result from the missing reward data not appearing in the system. For example, if a customer opens a dispute claiming that he is missing a reward, the MDC dispute resolution method 900 may find that no such reward is recorded in the system. If additional dispute data is needed 920-1, the MDC dispute resolution method 900 may have to gather more information 922 in order to determine whether the customer's dispute is genuine, and if so, where and when the error occurred. Further, more information may be gathered 922 in these cases to help prevent the error from recurring in the future or to signal other similar errors which may have occurred.

If additional dispute data is not needed 920-2, or if additional dispute data is needed 920-1 and the additional data has been gathered 922, the MDC dispute resolution method 900 may determine whether the transaction is authorized 914. If the transaction is not authorized 914-1, the MDC dispute resolution method 900 may terminate 950. If the transaction is authorized 914-2, the MDC dispute resolution method 900 may settle the dispute 930 and store or log data from the dispute resolution 940. At this point, the MDC dispute resolution method 900 may perform other dispute resolution steps or terminate 950.

By way of example, say a customer notices that a MDC discount coupon was not correctly applied to a transaction according to his credit card statement. The customer may call a toll-free telephone number of a customer service center owned by the affiliate store where the MDC was used. The phone call may be answered by an automated voice recognition system which may provide a menu of options to the customer. Those options may include connecting to a dispute resolution center. After selecting that option, the customer may be prompted for additional information relating, for example, to the dispute and MDC information.

In this example, the customer may provide such information (e.g. by voice, keypad, text, etc.) as his account number, an MDC tracking number, and the date, time, and location of his disputed transaction. Perhaps based on that information, the phone system may proceed to route the call and information to other systems which are more capable of processing the information. At some point during the process, the automated system (or possibly a live operator or other entity) may open a dispute resolution file, assigning a file tracking number and using that file to store the dispute information. In some cases, the automated system may be able to resolve the dispute by retrieving adequate information from the customer and from other systems, while in other cases, it may be necessary to connect the customer to a live operator or to promote the dispute resolution to systems or individuals with higher authority.

In this example, the automated system may find a record of the transaction, determine that the MDC was indeed mishandled, and that the disputed transaction value falls below a predetermined threshold amount. Because the transaction falls below the threshold amount and is authorized, the transaction may be settled. The phone system may inform the customer that his dispute has been resolved, and he should see a record of the resolved dispute on his next credit card statement. The system may further log the dispute information for further auditing purposes.

It will be appreciated that many MDC dispute resolution methods are possible for the many types of MDC-related disputes. Further, it will be appreciated that, depending on the type of dispute and the parties involved, dispute resolution may relate to sets of transactions, individual transactions, line items within transactions, profile information, or any other disputed data. As such, the invention should be construed broadly to account for these various types of MDC dispute resolution methods.

### Mobile Discount Certificate Handling Systems

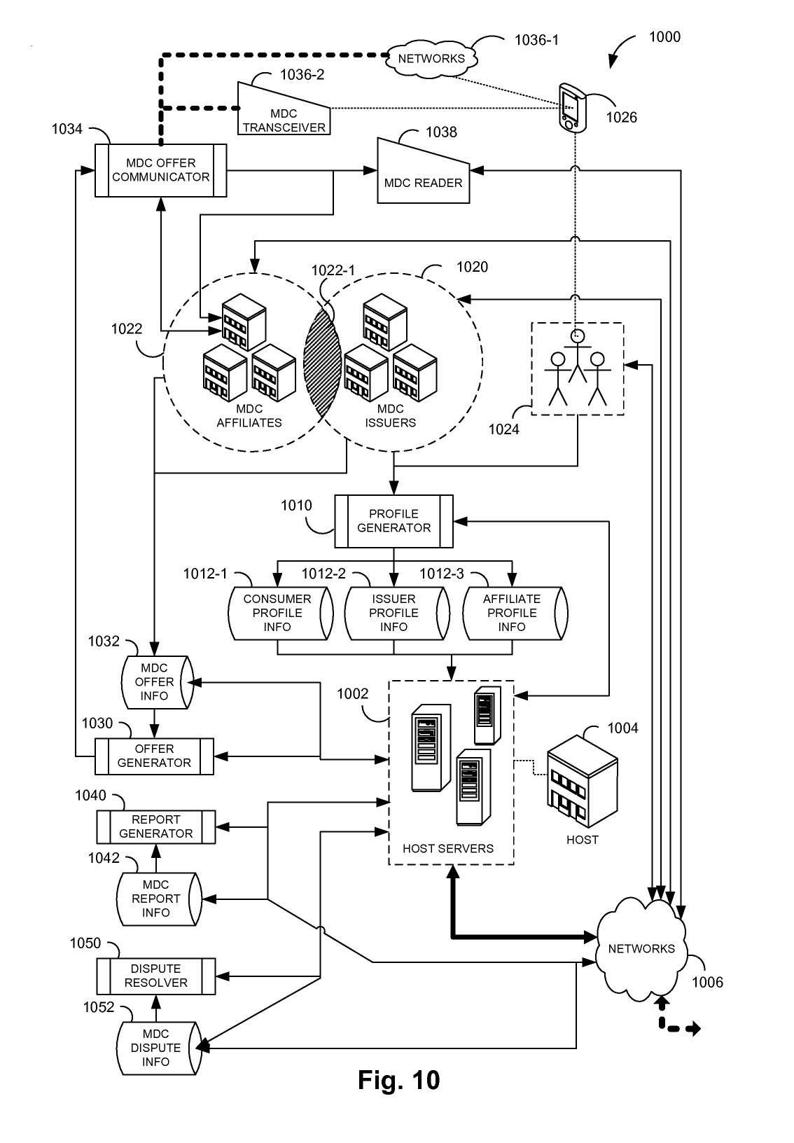

Many system configurations are possible for implementing the various embodiments of the invention and its related methods. A first set of systems is shown in FIG. 10, which provides a system block diagram illustrating various components for handling of MDCs using a mobile device according to various embodiments of the invention.

The exemplary MDC handling systems 1000 utilize a central host server 1002 to perform mobile handling of MDCs. This central host server 1002 may be a set of one or more data stores, collocated or distributed, and acting in series or parallel. Further, the central host server 1002 may store, have access to, or be able to provide any information or applications which may be useful to the handling of MDCs. The host server can also enable the customer to pay for goods, accumulate loyalty points, and redeem MDCs through a single transaction accomplished, for example, by waving their mobile device over a contactless reader.

Depending on different types of MDC programs, it may be desirable for the central host server 1002 to be owned, operated, maintained, or controlled by one or more parties internal or external to the MDC program. As illustrated, the central host server 1002 is owned by a host 1004 which is not an issuer or affiliate of the MDC program (e.g. an independent data server company, a company which participates in some MDC programs but not this particular one, etc.). However, it will be appreciated that an MDC issuer or affiliate may control some or all aspects of the central host server 1002 for a variety of reasons.

Further, the central host server 1002 may be in operative communication with, and possibly accessible through, one or more networks 1006. These networks may include internal networks (e.g. dedicated networks) or external networks (e.g. the Internet). Further, other applications or regulations may be necessary or desirable for handling network traffic, bandwidth, security, authority, etc.

One application which may be part of a MDC program (e.g. executed by the central host server 1002) may be a profile builder 1010 for gathering and processing profile information 1012 to use as part of the MDC program. This profile information 1012 may include information relating to some or all of the parties to a MDC program. Typical parties to MDC programs may involve MDC issuers 1020, MDC affiliates 1022, and MDC customers 1024. In some cases, a subset of MDC affiliates 1022-1 may also be MDC issuers 1020. Therefore, the profile generator 1010 may gather and generate, for example, customer profile information 1012-1, issuer profile information 1012-2, and affiliate profile information 1012-3. This profile information 1012 may be stored on the central host server 1002 in any useful file format in one or more files or other data stores.

Another application which may be part of a MDC program (e.g. executed by the central host server 1002) may be an offer generator 1030 for creating offers from MDC offer information 1032 to use as part of the MDC program. MDC offer information 1032 may be provided by any authorized and capable party, including MDC issuers 1020 and MDC affiliates 1022.

The offer generator 1030 may transmit the generated offer to an offer communicator 1034. The offer communicator 1034 may communicate directly or indirectly with customers' mobile devices 1026. In some cases, the offer communicator 1034 may communicate through one or more communication networks 1036-1. In this way, the offer communicator 1034 may be able to communicate offers directly to customers' mobile devices 1026 without intermediary systems or devices.

In other cases, the offer communicator 1034 may be in operative communication with devices, such as one or more MDC transceivers 1036-2. MDC transceivers 1036-2 may include any device capable of transmitting or receiving MDC offers to or from MDC customers 1024. It will be appreciated that MDC transceivers 1036-2 may utilize any one or more effective technology to that end, including but not limited to Bluetooth signals, near field communication (NFC) signals, radio frequency signals, audio signals, optical signals, electromagnetic fields, etc. Further, it will be appreciated that these MDC transceivers 1036-2 may be stand-alone devices (e.g. a visible or hidden transceiver in a point of sale location), or imbedded devices as part of any other object or system (e.g. part of a shelf tag, product display, promotional advertisement, etc.). For example, a customer may receive offers, including a special movie trailer, by waving his NFC-compatible phone over a NFC transceiver imbedded in a movie poster hanging outside a theater.

The offer communicator 1034 may also be in operative communication with devices, such as MDC readers 1038. MDC readers 1038 may include any device capable of reading a MDC as part of effectuating a MDC transaction. MDC readers 1038 may include dedicated devices (e.g. point-of-sale readers at checkout counters or kiosks, peripheral readers for business and home computers, etc.), or integrated devices (e.g. hardware readers imbedded into credit card readers, software MDC decoders for multi-purpose ports or sensors, etc.). Further, MDC readers 1038 may include any technology capable of reading and interpreting MDC transactions. In some cases, this may include manual reading by a live clerk, say a check-out clerk typing the MDC code into a register. In other cases, this may include similar or identical technology to that found in MDC transceivers 1036-2. In still other cases, this may include utilization of existing interfaces, like USB ports, barcode scanners, Bluetooth sensors, voice-recognition interfaces, etc.

By way of example, say a customer desires to redeem a MDC when leaving a point-of-sale. The customer may have a number of options. One set of options may include customer-initiated options, including the customer's waving his mobile device over a MDC reader, etc. Another set of options may include merchant-initiated options, including a clerk typing in a MDC code, scanning a mobile device display over a barcode reader, etc. A third set of options may include fully passive and/or automated options, including automatically checking for and settling MDC transactions as certain conditions are met. For example, MDC transactions may be automatically settled when a store detects that the customer has left the premises, at a certain time of each day, etc.

Yet another application which may be part of a MDC program (e.g. executed by the central host server 1002) may be a report generator 1040 for creating reports from MDC report information 1042 to use as part of the MDC program. MDC report information 1042 may be gathered from any effective source, including the central host server 1002 and networks 1006.

Still another application which may be part of a MDC program (e.g. executed by the central host server 1002) may be a dispute resolver 1050 for resolving MDC-related disputes as part of the MDC program. The dispute resolver 1050 may utilize MDC dispute information 1052 to resolve disputes, which may be gathered from any effective source, including the central host server 1002 and networks 1006.

Still another application which may be part of a MDC program (e.g. executed by the central host server 1002) may be to initiate and process the net amount of the goods against the credit, debit, stored value, ACH or similar funding account. This can be accomplished by calculating a total amount of goods purchased, reducing it by the MDC used and systematically charging the funding account by the net amount. This can be done in a single transaction for the customer when the MDC reader 1038 recognizes the mobile device 1026.

Of course many other applications and data may be required or desired as part of a MDC program. As such, the MDC handling system 1000 should be considered only one exemplary system. Also, it will be appreciated that components may be rearranged, added, removed, and otherwise altered without departing from the spirit of the system or the invention.

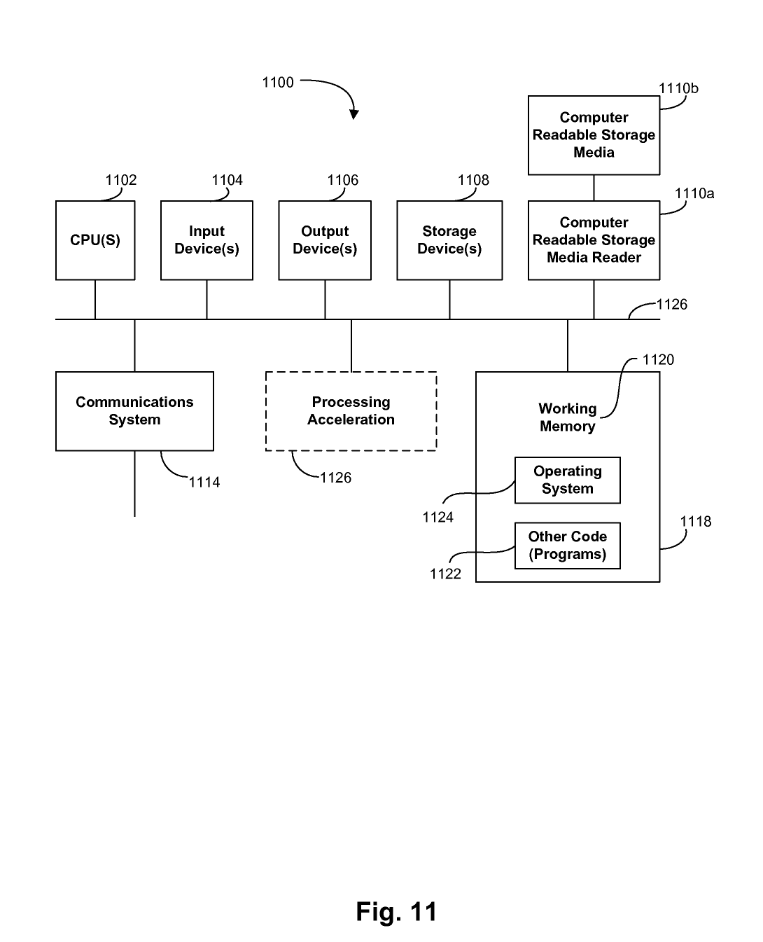

A second set of systems for use with various embodiments of the invention implements at least some of the methods of the invention using various computational devices. FIG. 11 provides a system block diagram illustrating computational devices for handling MDCs according to various embodiments of the invention. FIG. 11 broadly illustrates how individual system elements may be implemented in a separated or more integrated manner.

The computational device 1100 is shown comprised of hardware elements that are communicatively coupled via bus 1126, including a processor 1102, an input device 1104, an output device 1106, a storage device 1108, a computer-readable storage media reader 1110a, a communications system 1114, a processing acceleration unit 1116 such as a DSP (digital signal processor) or special-purpose processor, and a memory 1118. The computer-readable storage media reader 1110a is further coupled with a computer-readable storage medium 1110b, the combination comprehensively representing remote, local, fixed, and/or removable storage devices plus storage media for temporarily and/or more permanently containing computer-readable information. The communications system 1114 may comprise a wired, wireless, modem, and/or other type of interfacing connection and permits data to be exchanged over the architecture described in connection with embodiments of the invention.

The computational device 1100 also comprises software elements, shown as being currently located within working memory 1120, including an operating system 1124 and other code 1122, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

It will be appreciated that the many embodiments of the present invention may be realized in the context of many different types and scopes of systems. As such, the system described herein should be construed as only one exemplary system of the invention and the invention should be construed broadly to encompass all systems which may effectuate the invention.

### Conclusion

It will be appreciated that components of the systems described herein can be rearranged or connected differently to perform similar or identical functions; and steps of the methods described herein may be performed in alternate orders and still provide similar or identical results. Further, method steps should not be limited to the methods in which they are found; rather steps of one method may be performed by any other method in various embodiments of the invention. Thus, having described several embodiments, it will be recognized by those of skill in the art that various modifications, alternative constructions, and equivalents may be used without departing from the spirit of the invention. Accordingly, the above description should not be taken as limiting the scope of the invention.

What is claimed is:

1. A method for handling mobile discount certificates, the method comprising:
enrolling a plurality of participants in a mobile discount certificate program, wherein the participants comprise an issuer of the mobile discount certificates and a customer;
building a program participant profile for each of the participants;
creating one or more mobile discount certificates based on the program participant profiles; and
communicating the one or more mobile discount certificates to the customer.

2. The method of claim 1, wherein the participants further comprise an affiliate.

3. The method of claim 2, further comprising:
receiving mobile discount certificate redemption data; and
authorizing a transaction between the customer and the affiliate based on the mobile discount certificate redemption data.

4. The method of claim 3, further comprising:
settling the transaction between the customer and the affiliate;
calculating a mobile discount certificate redemption amount; and
applying the mobile discount certificate redemption amount against a total purchase amount so that the net amount is charged to a funding account in a single transaction.

5. The method of claim 4, further comprising reporting information related to the mobile discount certificate to the issuer.

6. The method of claim 5, further comprising updating the program participant profile for the issuer based on the information related to the mobile discount certificate.

7. The method of claim 1, wherein creating one or more mobile discount certificates based on the program participant profiles comprises:
receiving discount information from the issuer; and
creating the mobile discount certificate based on the discount information from the issuer.

8. The method of claim 7, wherein creating the mobile discount certificate is further based on the program participant profile for the customer.

9. The method of claim 7, wherein creating the mobile discount certificate is further based on the program participant profile for the issuer.

10. The method of claim 7, wherein creating the mobile discount certificate is further based on the program participant profile for the affiliate.

11. The method of claim 1, wherein communicating the one or more mobile discount certificates to the one or more customers comprises pushing the mobile discount certificates to a mobile device of the customer.

12. The method of claim 1, wherein communicating the one or more mobile discount certificates to the one or more customers comprises receiving a request for the mobile discount certificate and sending the mobile discount certificate to a mobile device of the customer in response to the request.

13. A system comprising:
a communication network;
a mobile device of a customer communicatively coupled with the communication network; and
a server communicatively coupled with the communication network and adapted to enroll a plurality of participants in a mobile discount certificate program, wherein the participants comprise an issuer of the mobile discount certificates and the customer, build a program participant profile for each of the participants, create one or more mobile discount certificates based on the program participant profiles; and communicate the one or more mobile discount certificates to the mobile device of the customer via the communication network.

14. The system of claim 13, further comprising a mobile discount certificate reader communicatively coupled with the communication network and adapted to receive mobile discount certificate redemption data from the mobile device of the customer and communicate the mobile discount certificate redemption data to the server via the communication network.

15. The system of claim 14, wherein the server is further adapted to receive the mobile discount certificate redemption data from the mobile discount certificate reader and authorize a transaction based on the mobile discount certificate redemption data.

16. The system of claim 15, wherein the server is further adapted to report information related to the mobile discount certificate to the issuer.

17. The system of claim 16, wherein the server is further adapted to update the program participant profile for the issuer based on the information related to the mobile discount certificate.

18. The system of claim 13, wherein creating one or more mobile discount certificates based on the program participant profiles comprises:
receiving discount information from the issuer; and
creating the mobile discount certificate based on the discount information from the issuer.

19. The system of claim 18, wherein creating the mobile discount certificate is further based on the program participant profile for the customer.

20. The system of claim 18, wherein creating the mobile discount certificate is further based on the program participant profile for the issuer.

21. A machine-readable medium having stored thereon a series of instruction which, when executed by a processor, cause the processor to handle mobile discount certificates by:
enrolling a plurality of participants in a mobile discount certificate program, wherein the participants comprise an issuer of the mobile discount certificates, a customer, and an affiliate;
building a program participant profile for each of the participants;
creating one or more mobile discount certificates based on the program participant profiles; and
communicating the one or more mobile discount certificates to the customer.

22. The machine-readable medium of claim 1, wherein creating one or more mobile discount certificates based on the program participant profiles comprises:
receiving discount information from the issuer; and
creating the mobile discount certificate based on the discount information from the issuer.

23. The machine-readable medium of claim 22, wherein creating the mobile discount certificate is further based on the program participant profile for the customer.

24. The machine-readable medium of claim 22, wherein creating the mobile discount certificate is further based on the program participant profile for the issuer.

25. The machine-readable medium of claim 22, wherein creating the mobile discount certificate is further based on the program participant profile for the affiliate.
